(19) United States
(12) Patent Application Publication
(10) Pub. No.: US 2018/0123262 A1
(43) Pub. Date: May 3, 2018

(54) Methods and Apparatus for Multiple Beam Antenna Structures

(71) Applicant: Custom Microwave, Inc., Longmont, CO (US)

(72) Inventors: Clency Lee-Yow, Longmont, CO (US); Philip E. Venezia, Longmont, CO (US); Nathaniel Farber, Boulder, CO (US); Amy Virginia Wichlacz, Boulder, CO (US)

(21) Appl. No.: 15/557,432

(22) PCT Filed: Mar. 11, 2016
(86) PCT No.: PCT/US16/22162

§ 371 Date: Sep. 11, 2017

Related U.S. Application Data
(60) Provisional application No. 62/132,359, filed on Mar. 12, 2015.

(51) Int. Cl. H01Q 21/06; H01Q 25/00

(52) U.S. Cl. CPC H01Q 21/064; H01Q 1/288; H01Q 25/00

(57) ABSTRACT

A multiple beam antenna structure. Network components (7, 8) may be integrated into panels (4, 5). Panels (4, 5) may be joined to form a panel architecture (6). Network paths (9) may be formed through the panel architecture (6) at joinder locations (9) of network components (7, 8) integrated into the panels (4, 5). The panel architecture (6) may have a reduced mass and permit increased network density.

### CROSS REFERENCE TO RELATED APPLICATION

This application is an international PCT Patent Application that claims the benefit of and priority to U.S. Provisional Patent Application No. 62/132,359, filed Mar. 12, 2015, said application and any priority case hereby incorporated herein by reference in its entirety.

### TECHNICAL FIELD

The present inventive technology relates to the field of multiple beam antennas. The present inventive technology may be used more particularly, but not exclusively, to create integrated network structures for such multiple beam antennas.

### BACKGROUND

Conventional multiple beam antennas, such as an array of feed elements used to illuminate a reflector antenna system or an array of radiating elements used as a direct radiating array antenna, typically may require a support structure to support the multiple networks generally utilized for the multiple beams. For example, a support structure may take the form of a rigid frame having a plurality of openings disposed there through, into which the networks corresponding to each beam are secured. Such an arrangement may be disadvantageous in several respects. For example, each individual network may require its own, separate installation into the frame. Additionally, the structure of the frame often may present limited spaces and tight tolerances, hindering the ability to access the areas required for installation. Moreover, the frame itself usually adds weight and mass to the structure, which may be a liability in certain multiple beam antenna applications, such as for multiple beam antennas placed on satellites for launch into space. The frame itself obviously also occupies space, which may take away space that otherwise could be utilized for network elements, perhaps thereby reducing the network density that can be achieved by the frame.

The foregoing problems related to conventional multiple beam antenna structures may represent a long-felt need for an effective solution to the same. While implementing elements may have been available, actual attempts to meet this need may have been lacking to some degree. This may have been due to a failure of those having ordinary skill in the art to fully appreciate or understand the nature of the problems and challenges involved. As a result of this lack of understanding, attempts to meet these long-felt needs may have failed to effectively solve one or more of the problems or challenges here identified. These attempts may even have led away from the technical directions taken by the present inventive technology and may even result in the achievements of the present inventive technology being considered to some degree an unexpected result of the approach taken by some in the field.

### DISCLOSURE OF THE INVENTION

In one embodiment, an object of the inventive technology may be to utilize a multiple beam antenna structure comprising at least a first panel joined to at least a second panel to form a panel architecture, at least two separate first network components integrated into said first panel, at least two separate second network components integrated into said second panel, at least two separate network component joinder locations where each said first network component is joined to a counterpart said second network component, and at least two separate network paths formed through said panel architecture via said two separate joinder locations.

Naturally, further objects of the inventive technology will become apparent from the description and drawings below.

### BRIEF DESCRIPTION OF THE DRAWINGS

FIG. 1 shows a multiple beam antenna structure in one exemplary embodiment.

FIG. 2 shows a panel architecture one exemplary embodiment.

FIG. 3 shows interface ports at differing sides of a multiple beam antenna structure in one exemplary embodiment.

FIG. 4 shows an array of panel architectures forming a multiple beam antenna structure in one exemplary embodiment.

FIG. 5 shows a staggered configuration for horns in one exemplary embodiment.

FIG. 6 shows horns in a staggered configuration in one exemplary embodiment.

### MODE(S) FOR CARRYING OUT THE INVENTION

The present inventive technology includes a variety of aspects, which may be combined in different ways. The following descriptions are provided to list elements and describe some of the embodiments of the present inventive technology. These elements are listed with initial embodiments, however it should be understood that they may be combined in any manner and in any number to create additional embodiments. The variously described examples and preferred embodiments should not be construed to limit the present inventive technology to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

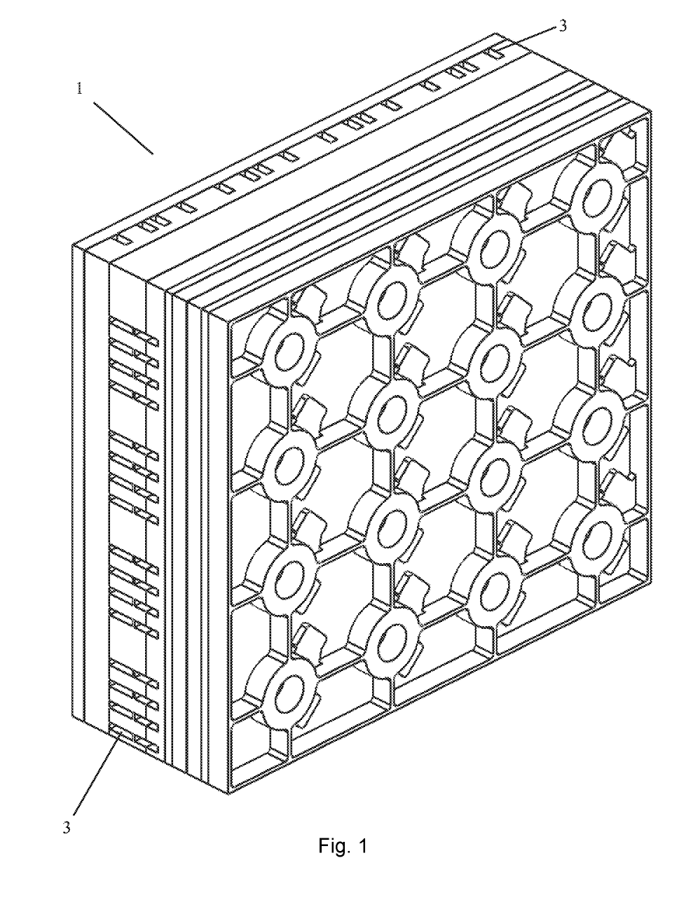

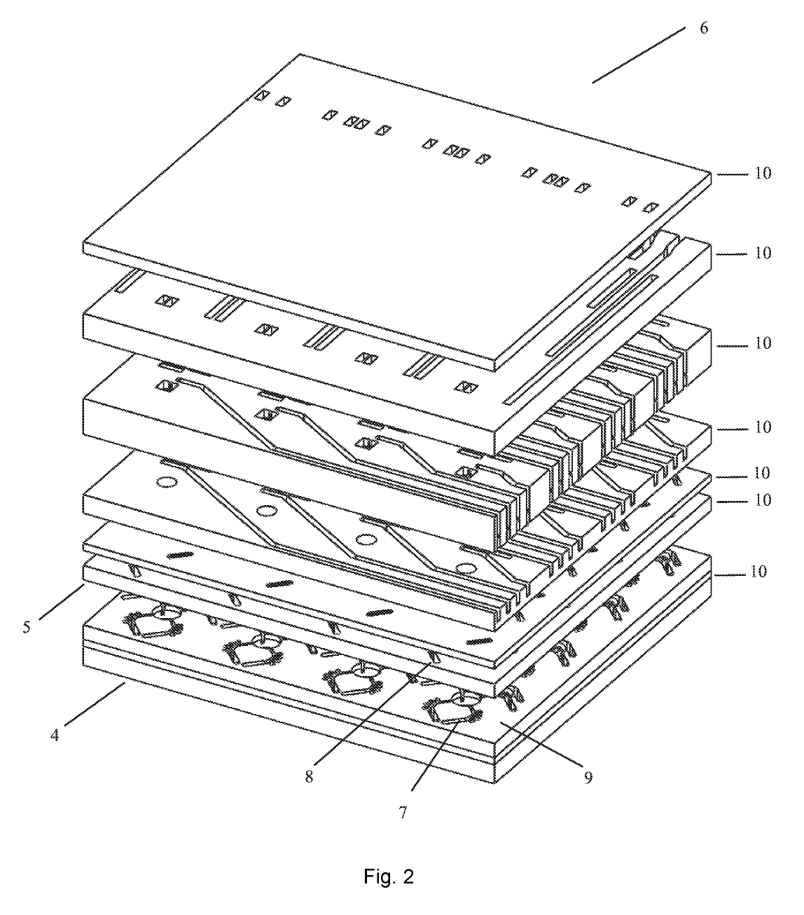

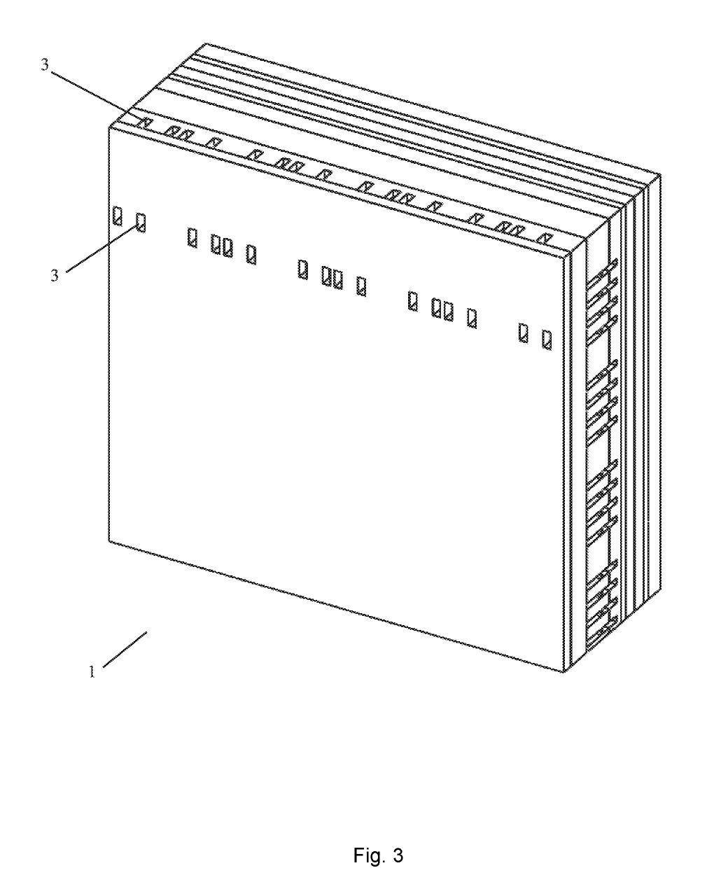

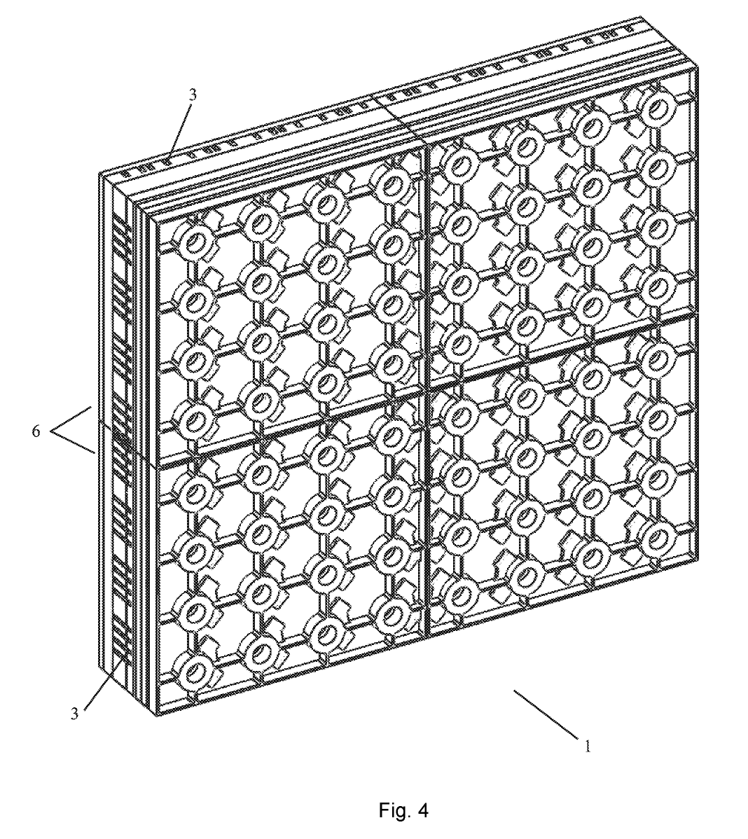

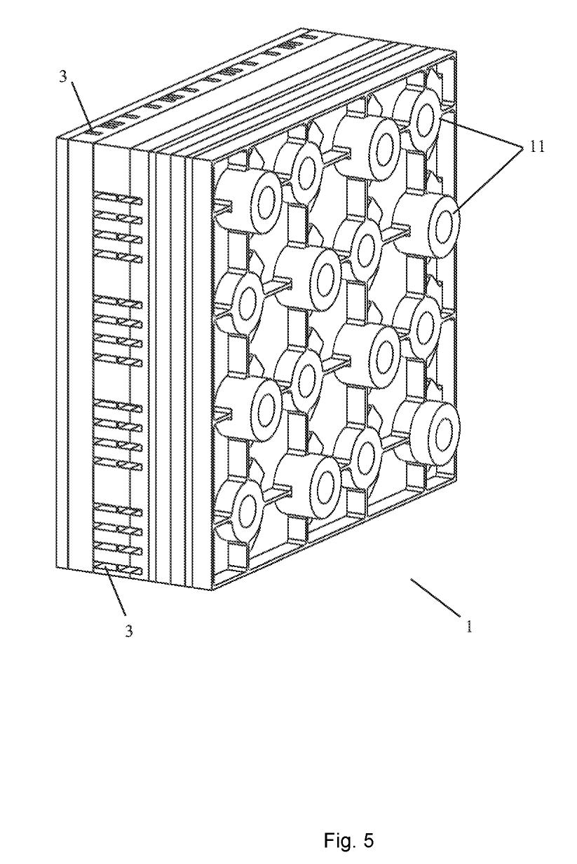

FIGS. 1-6 may show various aspects of a multiple beam antenna structure (1) in exemplary embodiments.

In various embodiments, the structure may involve the section of the multiple beam antenna (1) in which the networks and their supporting elements may be contained. A network may be considered to include those sections of the multiple beam antenna between a horn (2) (or the like) on one end and an interface port (3) (or the like) on the other end.

The multiple beam antenna structure (1) may have at least a first panel (4) joined to at least a second panel (5) to form a panel architecture (6). In some embodiments, panels may be rigid and rectangular, such as shown in the exemplary Figures, but need not be so. Other configurations for panels may include different shapes, curvatures, surface projections, and the like.

Various embodiments may involve joining panels into stacked, layered, or similar configurations. Such joining may be effected by any suitable means consistent with the inventive principles described herein. Joined panels may create all or part of a panel architecture (6).

A first panel (4) may have at least two separate first network components (7) integrated into the panel, and a second panel (5) may have at least two separate second network components (8) integrated into the panel. Network components may include any elements necessary to make up a network for a multiple beam antenna, such as transitions, rectangular waveguides, circular waveguides, polarizers, transducers, diplexers, and the like.

The first network component (7) and the second network component (8) generally may be sequential elements in the signal path for the network. For example, a signal routed through the network generally may first encounter first network component (7), then second network component (8), and then perhaps additional network components as may be discussed elsewhere herein.

By being separate, the network components may be understood to occupy discrete spaces in the panel architecture (6), for example such as may be employed by discrete network paths formed through the panel architecture (6).

A first network component (7) may be joined to a counterpart second network component (8) at a joinder location (9). The term joinder may be understood to involve the state by which two network components are joined. The term counterpart may be understood to involve one network component having a counterpart structure or functionality to another network component, for example such as successive network components in a signal path.

Naturally, at least two network component joinder locations (9) may be separate, such as may correspond to the separate nature of the network components being joined.

At least two separate network paths (10) may be formed through the panel architecture (6) via the separate joinder locations (9). A network path may provide a path for the signal carried by the network through the multiple beam antenna structure (1). From the foregoing, it may be evident that the multiple beam antenna structure (1) may have at least two separate network paths (10) formed through the panel architecture (6), which in various embodiments may correspond to the multiple beam capability of the multiple beam antenna.

As discussed, network components may be integrated into panels in various embodiments. Such integration may be understood to involve integrating both networking functionality for the network and structural support for the panel into a single component. For example, a network component integrated into a panel may comprise, be a part of, or otherwise make up some or all of the structure of a panel. A network component integrated into a panel thereby may not only be a component of a network, but indeed may itself be or provide structural support for the panel into which it is integrated.

This perhaps may be further understood by comparison to conventional multiple beam antennas, wherein network elements and structural elements generally may have been provided as separate and distinct members. For example, structural elements conventionally may be required as support members onto which network elements may be supported.

By way of contrast, in various embodiments the present inventive technology may utilize integrated network components that provide structure for the panel into which they are integrated. In various embodiments, this may include providing substantial structure for the panel or perhaps even substantially all structure for the panel.

Moreover, where a panel otherwise might require a dedicated structural element, an integrated network component in various embodiments may replace at least one such otherwise dedicated structural element, may replace a substantial number of such otherwise dedicated structural elements, or perhaps even may replace substantially all of such otherwise dedicated structural elements for the panel. In some embodiments, one or more panels indeed may be formed substantially entirely by such integrated network components.

As mentioned, at least two separate network components may be integrated into a panel. Naturally, a panel may have any number of separate network components integrated thereto consistent with the inventive principles discussed herein. In some embodiments, a typical such number may involve from 2 to 100 separate network components.

In various embodiments, first network components (7) may be network components of the same kind, and second network components (8) may be network components of the same kind. In some embodiments, network components of the same kind may be understood to involve identical network components, such as perhaps a particular manufacturer's make or model of a component. In other embodiments, network components of the same kind may be understood to include components sharing substantially similar structures or functions, such as components that are all polarizers but may polarize to different degrees, or the like.

In this manner, it may be seen that panels may represent stages of network paths (10) formed through a panel architecture (6). For example, a first panel may represent a polarization stage for each network path (10) routed there through, a second panel may represent a transduction stage for each network path (10) routed there through, and so forth. Of course, this example is merely illustrative, and should not limit the form or nature of stages that panels may represent consistent with the inventive principles discussed herein.

Moreover, it may be seen that a multiple beam antenna structure (1) indeed may have network paths (10) that comprise network paths of the same kind. In some embodiments, each network path (0) may comprise a network for one antenna of a multiple beam antenna. In various embodiments, a horn (2) may be joined at the front of each such network and an interface port (3) may be joined at the back end of each such network.

From the description herein, it may be seen that a multiple beam antenna structure (1) may be created by providing individual panels having a plurality of network components of the same kind integrated thereto. The panels may be joined to create a panel architecture (6), through which may be routed a plurality of network paths (10) of the same kind. Each network path may be formed by the joinder locations (9) of counterpart network components of individual panels.

Because network components may be integrated into the panels, such panels may require fewer or perhaps even no dedicated structural elements. Accordingly, the resulting panel architectures (6) may have a reduced mass as in relation to panels that otherwise may require dedicated structural elements, and may allow for increased network densities as in relation to panels that otherwise may require dedicated structural elements, since the space that otherwise may be occupied by structural elements instead may be occupied by network elements. Such panel architectures (6) similarly may permit increased flexibility and options in the placement of network elements, such as perhaps allowing interface ports (3) to be placed on differing sides of the panel architecture (6), horns to be configured in staggered configurations (11) or the like, and so forth.

Moreover, while much of the description herein has been described in terms of first and second panels, network components, and the like, it will be appreciated that any number of additional such panels, network components, and the like may be utilized consistent with the inventive principles discussed herein. For example, a multiple beam antenna structure (1) in various embodiments may involve one or more additional panels joined to a panel architecture (6) to form such panel architecture (6), at least two separate additional network components integrated into each such additional panel, at least two separate additional network component joinder locations where each said additional network component is joined to a counterpart network component, and wherein at least two separate network paths may be formed through the panel architecture (6) via the additional joinder locations.

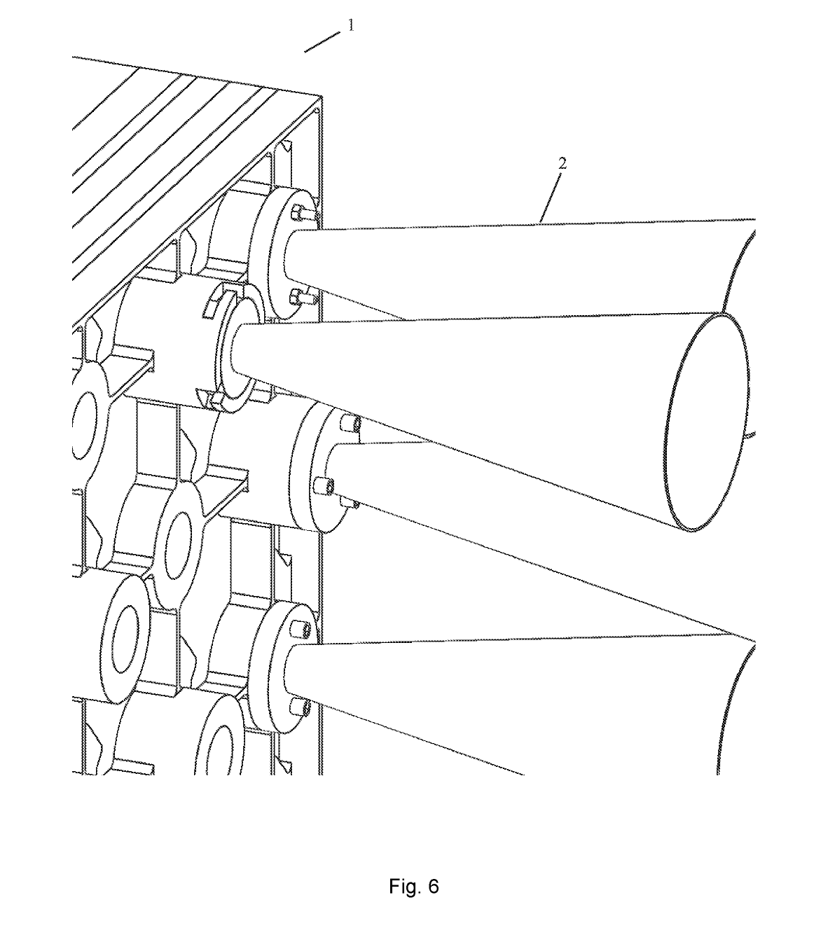

Additionally, in various embodiments a multiple beam antenna structure (1) may be made of panel architectures (6) configured into any suitable configuration consistent with the inventive principles discussed herein, for example such as into sub-arrays and arrays. This may be seen in one exemplary embodiment in FIG. 6.

Conventionally, when panels may have a large number of elements, thermal expansion may cause elements to move relative to their nominal positions. This may degrade radiation performance. In some cases this movement may not cause significant degradation, for example if the number of elements is small. Using the inventive principles described herein, a multiple beam antenna structure (1) may be separated into or otherwise made up of smaller arrays and/or sub-arrays, such as up to the point where movement due to thermal expansion may not cause significant degradation. Such arrays and sub-arrays may be interconnected, such as with tabs or brackets made of thermally stable material, such as invar, graphite composite material, or the like. The interconnecting structure also may be a material such as a graphite composite panel, for example instead of interconnections such as tabs or brackets.

In some applications, one or more beams may be required to point in different directions. Using the inventive principles described herein, in some embodiments a multiple beam antenna structure (1) may be separated into or otherwise made up of smaller arrays or sub-arrays, such as up to the point where pointing in the same direction may not cause significant degradation. These arrays and/or sub-arrays may be interconnected, such as with tabs or brackets at different angles to achieve the desired pointing. In various embodiments, the interconnecting structure also may be a material such as a graphite composite structure, or perhaps an other metallic structure.

In some embodiments, structural webbing or the like may be integrated into a panel, such that the structural webbing or the like may be capable of manipulation to orient each element and achieve a desired angle. The structural webbing or the like may be designed such that it may not reduce the integrity of the panel, and may provide additional mass reduction.

In some embodiments, a slight bend may be introduced at the interface between a network and a horn, such as to achieve a desired pointing. This bend may be optimized to minimize performance degradation.

As can be easily understood from the foregoing, the basic concepts of the present inventive technology may be embodied in a variety of ways. It involves both multiple beam antenna structuring techniques as well as devices to accomplish the appropriate multiple beam antenna structure. In this application, the multiple beam antenna structuring techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this patent application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements. Again, these are implicitly included in this disclosure. Where the inventive technology is described in device-oriented terminology, each element of the device implicitly performs a function. Apparatus claims may not only be included for the device described, but also method or process claims may be included to address the functions the inventive technology and each element performs. Neither the description nor the terminology is intended to limit the scope of the claims that will be included in any subsequent patent application.

It should also be understood that a variety of changes may be made without departing from the essence of the inventive technology. Such changes are also implicitly included in the description. They still fall within the scope of this inventive technology. A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “structure” should be understood to encompass disclosure of the act of “structuring”—whether explicitly discussed or not—and, conversely, were there effectively disclosure of the act of “structuring”, such a disclosure should be understood to encompass disclosure of a “structure” and even a “means for structuring.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed below or other information statement filed with the application are hereby appended and hereby incorporated by reference, however, as to each of the above, to the extent that such information or statements incorporated by reference might be considered inconsistent with the patenting of this/these inventive technology(ies) such statements are expressly not to be considered as made by the applicant(s).

### LIST OF REFERENCES TO BE INCORPORATED BY REFERENCE

### I. US Patents

| Patent No. | Kind Code | Issue Date | Patentee |
|---|---|---|---|
| 5,126,705 | | 1992 Jun. 30 | Carnevali et al. |
| 4,862,186 | | 1989 Aug. 29 | Strider |
| 7,564,421 | B1 | 2009 Jul. 21 | Edwards et al. |
| 8,988,300 | B2 | 2015 Mar. 24 | Runyon et al. |
| 5,243,357 | | 1993 Sep. 7 | Koike et al. |
| 7,948,443 | B2 | 2011 May 24 | Bullock et al. |
| 5,231,409 | | 1993 Jul. 27 | Astier et al. |

### II. Foreign References

| Patent No. | Country Code | Kind Code | Issue Date | Patentee |
|---|---|---|---|---|
| 0,798,209 | EP | B1 | 2004 Nov. 24 | Cherette |

### III. Nonpatent Literature

Schneider, Michael et al. Antennas for Multiple Spot Beam Satellites.
CEAS Spalce J (2011) 2: 59-66, 10 Aug. 2011
Porecki, Nicola et al. Flexible Payload Technologies for Optimising
Ka-ban Payloads to Meet Future Business Needs. Astrium Ltd. Anchorage
Road. Date unknown.

Thus, the applicant(s) should be understood to have support to claim and make a statement of invention to at least: i) each of the multiple beam antenna structure devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

In addition and as to computer aspects and each aspect amenable to programming or other electronic automation, the applicant(s) should be understood to have support to claim and make a statement of invention to at least: xv) processes performed with the aid of or on a computer as described throughout the above discussion, xvi) a programmable apparatus as described throughout the above discussion, xvii) a computer readable memory encoded with data to direct a computer comprising means or elements which function as described throughout the above discussion, xviii) a computer configured as herein disclosed and described, xix) individual or combined subroutines and programs as herein disclosed and described, xx) a carrier medium carrying computer readable code for control of a computer to carry out separately each and every individual and combined method described herein or in any claim, xxi) a computer program to perform separately each and every individual and combined method disclosed, xiii) a computer program containing all and each combination of means for performing each and every individual and combined step disclosed, xxiii) a storage medium storing each computer program disclosed, xxiv) a signal carrying a computer program disclosed, xxv) the related methods disclosed and described, xxvi) similar, equivalent, and even implicit variations of each of these systems and methods, xxvii) those alternative designs which accomplish each of the functions shown as are disclosed and described, xxviii) those alternative designs and methods which accomplish each of the functions shown as are implicit to accomplish that which is disclosed and described, xxix) each feature, component, and step shown as separate and independent inventions, and xxx) the various combinations and permutations of each of the above.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still tall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A multiple beam antenna structure comprising:
at least a first panel joined to at least a second panel to form a panel architecture;
at least two separate first network components integrated into said first panel;
at least two separate second network components integrated into said second panel;
at least two separate network component joinder locations where each said first network component is joined to a counterpart said second network component;
at least two separate network paths formed through said panel architecture via said two separate joinder locations.

2. A multiple beam antenna structure as described in claim 1 wherein said integrated network components provide structure for said panel into which they are integrated.

3. A multiple beam antenna structure as described in claim 2 wherein said structure comprises structure selected from the group consisting of substantial structure for said panel, at least one replaced otherwise dedicated structural element for said panel, and a substantial number of replaced otherwise dedicated structural elements for said panel.

4. A multiple beam antenna structure as described in claim 2 wherein said structure comprises structure selected from the group consisting of substantially all structure for said panel and substantially all replaced otherwise dedicated structural elements for said panel.

5. A multiple beam antenna structure as described in claim 1 wherein each said panel is formed substantially entirely by said integrated network components.

6. A multiple beam antenna structure as described in claim 1 wherein each said at least two separate network components comprise 2-100 separate network components.

7. A multiple beam antenna structure as described in claim 1 wherein said first network components comprise network components of the same kind and wherein said second network components comprise network components of the same kind.

8. A multiple beam antenna structure as described in claim 7 wherein said network paths comprise network paths of the same kind.

9. A multiple beam antenna structure as described in claim 8 wherein each network path comprises a network for one antenna of a multiple beam antenna.

10. A multiple beam antenna structure as described in claim 9 further comprising a horn joined at the front end of each said network and an interface port joined at the back end of each said network.

11. A multiple beam antenna structure as described in claim 9 wherein at least two said interface ports are located on differing sides of said panel architecture.

12. A multiple beam antenna structure as described in claim 1 further comprising a reduced mass of said panel architecture.

13. A multiple beam antenna structure as described in claim 1 further comprising an increased network density of said panel architecture.

14. A multiple beam antenna structure as described in claim 1 further comprising:
one or more additional panels joined to said panel architecture to form said panel architecture;
at least two separate additional network components integrated into each said additional panel;
at least two separate additional network component joinder locations where each said additional network component is joined to a counterpart network component;
and wherein said at least two separate network paths formed through said panel architecture comprise at least two separate network paths formed through said panel architecture via said additional joinder locations.

15. A system substantially as herein described with reference to any one or more of the Figures and Description.

16. A process comprising any of the steps as shown in FIGS. 1-6, separately, in any combination or permutation.
